(19) United States
(12) Patent Application Publication
(10) Pub. No.: US 2025/0378584 A1
(43) Pub. Date: Dec. 11, 2025

(54) MEASURING CROSSTALK FOR A THREE-DIMENSIONAL DISPLAY SYSTEM

(71) Applicant: GOOGLE LLC, Mountain View, CA (US)

(72) Inventors: John D. Perreault, Mountain View, CA (US); Haiwei Chen, San Jose, CA (US)

(21) Appl. No.: 19/231,058

(22) Filed: Jun. 6, 2025

Related U.S. Application Data
(60) Provisional application No. 63/656,944, filed on Jun. 6, 2024.

(51) Int. Cl. G06T 7/80; G06V 20/64; H04N 13/15; H04N 13/239; H04N 13/302

(52) U.S. Cl. CPC G06T 7/85; G06V 20/647; H04N 13/15; H04N 13/239; H04N 13/302; G06T 2207/10012; G06T 2207/30244; G06V 2201/02; H04N 2213/002

(57) ABSTRACT

According to at least one implementation, a method includes identifying a first image of a display from a first camera and a second image of the display from a second camera. The method further includes determining a crosstalk for the display based on the first image and the second image.

### CROSS-REFERENCE TO RELATED APPLICATION

This application claims the benefit of U.S. Provisional Application No. 63/656,944, filed Jun. 6, 2024, the disclosure of which is incorporated herein by reference in its entirety.

### BACKGROUND

A three-dimensional (3D) display is a technology that visually presents three-dimensional imagery, creating a perception of depth for the viewer. The display can achieve this by presenting separate images to each eye through glasses (like stereoscopic systems that use polarized or shutter glasses) or glasses-free techniques (autostereoscopic displays) that rely on lenticular lenses or parallax barriers. These displays provide a sense of realism and immersion, commonly used in applications like gaming, virtual reality, medical visualization, and augmented reality.

### SUMMARY

This disclosure relates to systems and methods for measuring crosstalk for a three-dimensional (3D) display system. In at least one implementation, a display can be configured to provide a first image for a user's right eye and a second image for the user's left eye. A first camera can be configured to capture an image of the display acting as the user's right eye, while a second camera can capture an image of the display acting as the user's left eye. In some implementations, the images captured by the first and second cameras can be used to determine crosstalk associated with the display. Crosstalk for a 3D display is when the image meant for one eye leaks into the view of the other eye, which can cause blurriness or affect the clarity of the 3D image. In some implementations, a first color and/or pattern can be displayed for the left eye, while a second color and/or pattern is displayed for the right eye. Based on the images captured by the first and second cameras, the system can determine how much of the colors and/or patterns are leaked (i.e., crosstalk) to each eye.

In some aspects, the techniques described herein relate to a method including: identifying a first image of a display from a first camera; identifying a second image of the display from a second camera; and determining a crosstalk for the display based on the first image and the second image.

In some aspects, the techniques described herein relate to a system including: at least one processor; a computer-readable storage medium operatively coupled to the at least one processor; and program instructions stored on the computer-readable storage medium that, when executed by the at least one processor, direct the system to perform a method, the method including: identifying a first image of a display from a first camera; identifying a second image of the display from a second camera; and determining a crosstalk for the display based on the first image and the second image.

In some aspects, the techniques described herein relate to a method including: receiving a set of images from a camera, the set of images capturing an autostereoscopic display, and the camera representing an eye of a user; and determining a crosstalk for the autostereoscopic display based on the set of images.

The accompanying drawings and the description below outline the details of one or more implementations. Other features will be apparent from the description, drawings, and claims.

### BRIEF DESCRIPTION OF THE DRAWINGS

FIG. 1 illustrates a computing environment to determine crosstalk associated with a display according to an implementation.

FIG. 2 illustrates a method of determining crosstalk associated with a display according to an implementation.

FIG. 3 illustrates an operational scenario of capturing images to determine crosstalk associated with a display according to an implementation.

FIG. 4 illustrates an operational scenario of determining a pose for a test camera system according to an implementation.

FIG. 5 illustrates an operational scenario of determining extrinsic parameters associated with a test camera system according to an implementation.

FIG. 6 illustrates an operational scenario for changing a display configuration based on measured crosstalk according to an implementation.

FIG. 7 illustrates a computing system to determine crosstalk associated with a display according to an implementation.

### DETAILED DESCRIPTION

A 3D display is a type of visual technology that presents images with depth perception, allowing viewers to perceive visuals in three dimensions (i.e., height, width, and depth) instead of the two dimensions offered by traditional screens. The 3D display can achieve this effect through various methods, such as stereoscopic displays, which deliver slightly different images to each eye, simulating the natural binocular vision humans use to perceive depth. Common approaches include active glasses (shutter glasses), passive polarized glasses, autostereoscopic displays (which don't require glasses), and holographic displays.

Shutter glasses work by rapidly alternating between blocking the view of each eye in sync with a display showing alternating left-eye and right-eye images. This synchronization creates the illusion of depth as the brain combines these separate views into a single three-dimensional perception. Polarized lenses can filter light waves so that each eye receives images polarized differently (e.g., using vertical polarization for one eye and horizontal polarization for the other). A corresponding polarized display projects separate images simultaneously, allowing users to merge them into a single 3D visual perception. In contrast to the examples of glasses (i.e., shutter and polarized glasses), autostereoscopic displays produce a 3D effect without special glasses by directing separate images to each eye. Autostereoscopic displays can use methods like lenticular lenses or parallax barriers (i.e., optical components placed over the screen) to ensure each eye sees a slightly different perspective, enabling the user to perceive depth naturally. This allows viewers to experience three-dimensional visuals directly from the display.

A lenticular lens is a sheet of magnifying lenses (i.e., lenticules) placed on top of a screen. These lenses bend light so that each eye sees different pixels on the display. The display can show images, alternating strips for the left and right eyes, and the lenses guide each strip to the correct eye. This separation can provide depth and create a 3D effect. In some implementations, displays can use parallax barriers. A parallax barrier is a layer placed in front of a screen (e.g., liquid crystal display) that has narrow slits aligned vertically. These slits block certain light rays so that each eye sees a different set of pixels, creating a sense of depth without the need for glasses. The 3D effect works by sending slightly different images to each eye. However, although different technologies can provide 3D visuals to a user, difficulties arise in determining the effectiveness of separating the images directed to each eye. For example, while a display can direct different images to each eye of a user, at least a portion of the light for a first eye (e.g., right eye) can be received by a second eye (e.g., left eye). The unwanted light received by the second eye is referred to as crosstalk. Crosstalk refers to the undesirable leakage of image information meant for one eye being seen by the other, which can worsen the perceived 3D effect and cause ghosting or double images. This phenomenon occurs when the mechanisms that direct separate images to each eye, such as parallax barriers or lenticular lenses, are not aligned or the viewer is not positioned at the optimal angle. High levels of crosstalk can reduce the clarity and effectiveness of the 3D experience, causing visual discomfort and reducing the overall quality of the stereoscopic image.

In at least one technical solution, a device is configured to capture images of a display and determine a measurement of the crosstalk from the display. In at least one implementation, the device identifies a first image from a first camera and a second image from a second camera. Each camera can be configured to represent a user's eyes. For example, a first camera may capture the image from the display as the left eye of a user, while a second camera may capture the image from the display as the right eye of the user. In some examples, the device can be configured to adjust the pupillary distance and the orientation of the cameras relative to the display. From the images by the first and second cameras, the device can be configured to determine crosstalk or a crosstalk measurement for the display based on the first and second images. In some examples, the crosstalk measurement comprises one or more percentages that indicate the amount of light from a first channel (e.g., content for the left eye) identified in the second channel (e.g., content targeted for the right eye). In some examples, the percentages can be calculated for different portions of the display, permitting different crosstalk measurements for different display areas. The technical effect permits display producers to identify crosstalk issues associated with a particular display.

In at least one implementation, the device is configured to calibrate the cameras before determining crosstalk values associated with the display. In some examples, the device can be configured to identify intrinsic parameters, such as focal length, distortion parameters, principal points, etc. To determine the intrinsic parameters, the device can execute a model that uses imaging information from the cameras to generate the parameters. In some implementations, the device can be configured to use a pattern, such as a chessboard+ArUco (ChArUco) pattern, that is displayed and captured at different poses by the cameras. ChArUco calibration involves capturing multiple images of the ChArUco board from various angles and distances to detect the markers and chessboard corners. These detected points are then used to compute the camera's intrinsic parameters and distortion coefficients through a calibration algorithm. In some implementations, the device can be configured to use a model that processes the images to determine the required values.

Once the cameras are calibrated and the intrinsic parameters are identified in association with the cameras, the device can be configured to capture a ChArUco pattern (or any other pattern) on the display to determine the extrinsic pose of the cameras. The extrinsic pose is used to define the location of the cameras relative to the display, wherein the cameras are used to simulate a user viewing the display. In some implementations, the display system can use sensors to track the user's head or eye position in the physical environment. This tracking allows the display to adjust the image shown so that each eye receives a slightly different perspective, creating a sense of depth without glasses. Techniques like lenticular lenses or parallax barriers can direct different images to each eye based on the viewing angle. For example, the display system can be configured to present a three-dimensional virtual object, such as a soccer ball. The system includes one or more sensors to determine the position of the user's head or eyes. Based on the tracked position, the display dynamically adjusts the output by directing different image views to each eye using a parallax barrier or lenticular lens array. As the user moves laterally, the system can be configured to update the projected views to maintain the perception of depth. The pose position can be used to define the crosstalk detected at that pose.

After the extrinsic pose is determined, the device can further be configured to display at least one image that can be used to calculate the crosstalk for the extrinsic pose (i.e., coordinates of the cameras). In some implementations, the device will display black, 3DblackGreen, 3DgreenBlack, and/or green to determine the amount of undesirable light from a first channel (e.g., displayed for the left eye) in the second channel (e.g., the image displayed for the right eye). 3DblackGreen and 3DgreenBlack are merely examples of 3D test patterns, and other patterns can be used to provide a different image for the left and right eye. In some examples, the device is configured to identify the crosstalk over various display portions. Thus, while the crosstalk for a first channel may be a first value for the first portion of the display, the crosstalk for the first channel may differ for a second portion. In some implementations, the device displays black for both the right and left eye perspective cameras. The device also displays a color (e.g., green) for both the right and left eye perspective cameras. The device can also display one color (e.g., green) for a first camera and black for the second camera. The device can then display black for the first camera and the color for the second camera. Based on the images, the device can determine the amount of crosstalk from the display by determining the amount of undesirable light received at the cameras representing the user's eyes.

In some examples, crosstalk can be calculated as a ratio or percentage for at least a portion of the screen. Using the camera for the left eye as an example, a system can capture an image at the left eye and calculate crosstalk by dividing the light intensity received from the right eye (i.e., unintentional light intended for the right eye) by the summation of the light intensity from the right eye and the light intensity intended for the left eye. The value can be calculated for different portions of the display in some examples.

In some implementations, the process is repeated for different poses to simulate different view positions for the user. The device can be configured to indicate the amount of crosstalk observed at each of the different poses. Accordingly, while the camera representing a user's right eye may capture a first amount of crosstalk in a first position, the camera can capture a second amount of crosstalk at a different position or pose. In some implementations, the device can be configured to generate a summary associated with the crosstalk across different poses. As at least one example, the device can measure crosstalk associated with the left eye channel and the right eye channel at different poses. The device can then predict the crosstalk associated with the display at different poses, orientations, or distances. In some examples, the device can predict the crosstalk for the right eye channel and the left eye channel for a particular pose or coordinate relative to the display. As a technical effect, rather than testing every pose, a subset of the poses can be used to predict the crosstalk at different viewing angles, assisting the developer in tuning the display.

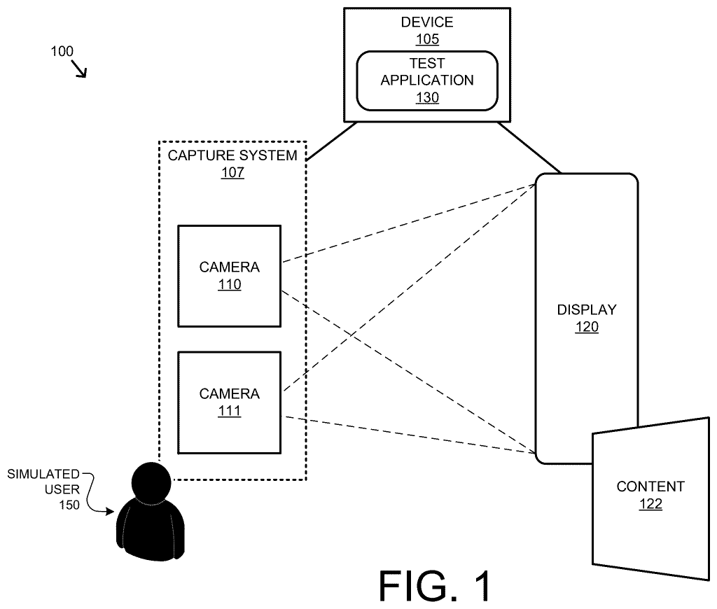

FIG. 1 illustrates a computing environment 100 to identify crosstalk associated with a display according to an implementation. Computing environment 100 includes device 105, capture system 107, display 120, content 122, and simulated user 150. Capture system 107 further includes camera 110 and camera 111, which are used to capture images of display 120 as simulated user 150. Capture system 107 can include a mannequin or a mask that can act as a stand-in for the user's head (i.e., simulated user 150). One or more cameras can track the mask or mannequin in some examples to know the user's location relative to display 120. Device 105 provides test application 130, which is used to identify crosstalk from display 120.

In computing environment 100, display 120 is representative of a 3D display (i.e., an autostereoscopic 3D display) that can create the illusion of depth without the need for special classes or other headgear. Display 120 can use technologies such as parallax barriers or lenticular lenses to provide the desired effect in some implementations. These methods direct different images to each eye by aligning multiple views of the same scene. Parallax barriers can consist of a series of slits that block portions of the image so that each eye sees a different perspective. For example, the left eye can view first light from the display corresponding to a first image, and the right eye can view second light from the display corresponding to a second image. The first and second images are separated using barriers or slits that limit the light viewable from each eye.

As an alternative to parallax barriers, lenticular lenses use an array of magnifying lenses to project separate images to each eye. By ensuring that each eye perceives slightly different images, these displays create a stereoscopic effect, allowing viewers to experience 3D visuals from certain angles directly on the screen. However, display 120 may encounter a technical problem of crosstalk based on the configuration of the display and/or the location of the user relative to the display.

In at least one technical solution, device 105 and capture system 107 are provided that can identify or measure the crosstalk at different poses. Device 105 may represent one or more computers that work with cameras 110-111 to measure the crosstalk at different poses and provide the information to a developer who can adjust the settings of the device, change one or more software settings, or take some other action to improve the crosstalk associated with display 120.

In at least one example, device 105 can be configured to establish a camera calibration for cameras 110-111. Camera calibration is used to identify intrinsic parameters, such as focal length, distortion parameters, principal points, or other parameters associated with the camera. In at least one implementation, device 105 and test application 130 can be configured to display a pattern on display 120 and take images at different poses to solve the intrinsic parameters. Intrinsic parameters for two cameras acting as human eyes (i.e., camera 110 and camera 111) are identified through a calibration process that involves capturing images of a known calibration pattern, such as a checkerboard, from various angles and positions. This data is then used to compute the camera matrix and distortion coefficients, which describe the internal characteristics of each camera, including focal length, principal point, and lens distortion.

In some implementations, the intrinsic parameters define how the camera maps 3D points in the real world to 2D points on its image sensor. These include the focal length, the optical center (which can be near the center of the image), and other factors (e.g., skew or pixel aspect ratio). The parameters are used to understand the internal geometry of the camera, which can be used for depth estimation, correcting image distortion, or performing other actions associated with 3D applications. In some examples, the intrinsic parameters can be used to interpret where the user is viewing from and enable the system to estimate the user's viewpoint. This allows the cameras to act as a stand-in or virtual viewer of the content provided by display 120.

Once the intrinsic parameters associated with cameras 110 and 111 are determined, device 105 and test application 130 can capture one or more additional images to determine the crosstalk provided by display 120. In some implementations, device 105 can be configured to identify the current location of capture system 107 using a pattern captured by the cameras (e.g., the same pattern used for calibration). The device can then capture at least one further image by each camera of cameras 110-111 to determine the crosstalk at the current pose. In some examples, device 105 will display patterns or 3D encoded images on display 120 that are then captured by the cameras to determine the crosstalk from the display. Crosstalk can be determined by analyzing the interference and signal leakage between the cameras' sensors. The process can involve controlled testing with known sources of signal (e.g., the patterns and encoded images) and observing the impact on each camera's captured images. For example, when an image is intended to be black from the display, device 105 can be configured to determine when (and how much) additional light is present in an image captured from the camera. The extra light can be measured as a percentage in some examples and can be identified across different screen portions. The percentage is calculated as the ratio of the leaked image signal to the intended image signal in some examples and can be calculated for the entirety of the display at that pose. The process can then be repeated at different poses to identify different crosstalk measurements based on perspective. In some implementations, trends or crosstalk measurements at different poses can be used to predictively model the crosstalk from poses that have not been tested by device 105 and cameras 110-111. Computing environment 100 can predict the crosstalk associated with display 120 at different poses, orientations, or distances. In some examples, the device can predict the crosstalk for the right eye channel and the left eye channel for a particular pose or coordinate relative to the display. As a technical effect, rather than testing every pose, a subset of the poses can be used to predict the crosstalk at different viewing angles, assisting the developer in tuning the display.

In some implementations, the crosstalk measurement can be used to update the configuration associated with display 120. The update can change the lens configuration, the projection methods, or other parameters related to display 120. In some examples, the updates can be implemented by a user. In some examples, the updates can be implemented automatically based on the determined crosstalk measurements. The process can then be repeated to determine whether the updated configuration improves crosstalk associated with display 120.

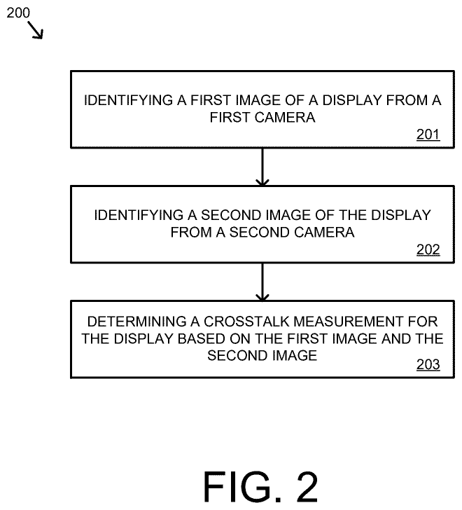

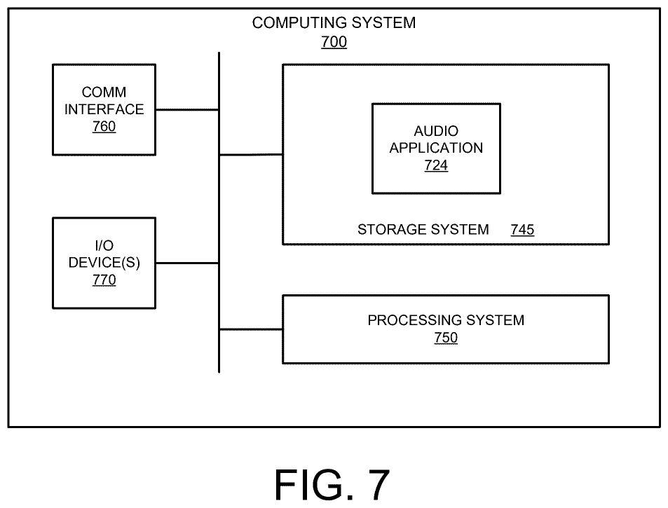

FIG. 2 illustrates method 200 of determining crosstalk associated with a display according to an implementation. Method 200 can be performed by one or more computing devices, such as servers, desktops, or other computing devices. In some implementations, method 200 can be performed by device 105 of FIG. 1 or computing system 700 of FIG. 7.

Method 200 includes identifying a first image of a display from a first camera at step 201 and identifying a second image of the display from a second camera at step 202. In some implementations, the first and second cameras are configured to act as a simulated display user. The first camera can capture content as a simulated left eye of a user, while the second camera can capture content as a simulated right eye for the user. In some implementations, the display corresponds to a 3D or autostereoscopic 3D display that can create the illusion of depth without needing special classes or other headgear. An autostereoscopic display creates a 3D effect without requiring glasses by showing slightly different images to each eye. The display uses optical layers like lenticular lenses or parallax barriers in front of the screen to direct light from other pixels toward each eye. These layers are aligned so that each eye only sees the intended image for that eye. The user's brain then merges the two views into a single 3D scene, creating the perception of depth. Here, the first and second cameras act as the user to capture images intended for each eye. In some implementations, the cameras can be mounted to a dummy, mannequin, or representation of a user. The representation can permit cameras or other sensors to track the user and direct images to the corresponding eye. For example, a 3D display can be coupled to cameras or sensors that detect the position of the user's eyes or head. The display can then be configured to shift the image projection, in some examples by adjusting the angle of lenses or light direction, so that each eye sees the correct view.

In some implementations, each camera can capture multiple images associated with the display. For example, a camera representing the left eye can capture the display when it is displaying a first color for both eyes (e.g., green), capture the display when it is displaying a second color for bother eyes (e.g., black), capture the display when it is displaying the first color for the left eye and the second color for the right eye, and capture the display when it is displaying the second color for the left eye and the second color for the right eye.

Method 200 further includes determining a crosstalk for the display based on the first image and the second image at step 203. In some implementations, crosstalk can be measured by measuring how much of an image is received by the unintended camera representing the user's eye. For example, the display can provide a first image for the camera representing a user's right eye, the first image including a first color (e.g., green). The display can further provide a second image for the camera representing the user's right eye, the second image including a second color (e.g., black). The device can determine the crosstalk to the right eye based on the amount of light (i.e., green) received by the camera representing the user's right eye. In some implementations, the ratio of light to intended light is calculated to show how much unwanted overlap occurs between the two views. This ratio can be determined as a percentage in some examples. In some examples, the crosstalk can include undesirable light associated with each eye (e.g., a first measurement for the left eye and a second for the right eye). This can be calculated using different images for the left and right eye as described above.

In some implementations, the crosstalk can include different values for different portions of the display. For example, from the images captured, the system can determine that for a user's left eye, portions of the display include a greater amount of crosstalk than other portions of the display (e.g., the upper right may include more crosstalk than the rest of the display). In some examples, the crosstalk can be calculated for different portions (e.g., subsets of one or more pixels) in the display. As at least one technical effect, an engineer or calibrator can identify portions of the display with undesirable amounts of crosstalk. In some examples, these portions can be highlighted or promoted when they satisfy a threshold value. For example, from the camera representing a user's right eye, a display representation can be generated that indicates the crosstalk associated with different portions. Portions that exceed or satisfy criteria can be highlighted, permitting a calibrator or engineer to make changes associated with the display. In some examples, a system can be configured to adjust parameters associated with the display, such as the lenses, and initiate a second crosstalk test (i.e., method 200). The second crosstalk test can determine whether the adjustments corrected the crosstalk issues identified during the first test.

In some implementations, the crosstalk can be determined for different positions or poses in space. In some examples, the display can provide a pattern and capture images using both the left camera and right camera to determine the relative pose of the display. A pose defines the position and orientation of an object in three-dimensional space. In some implementations, the system can use a ChArUco pattern, which consists of an array of markers used to identify the position and orientation of objects in 3D space. A ChArUco pattern is a visual marker system that combines the benefits of chessboard corners for precise detection with ArUco markers for unambiguous identification. Once the pose is determined, the device can further identify the crosstalk associated with the display using the selected pose. The process can be repeated at different poses to permit the determination of different crosstalk for different poses. For example, the display can calculate the crosstalk associated with a first pose to the left of the display and the crosstalk associated with the second pose to the right of the display.

In some implementations, before calculating the crosstalk associated with the display, the system can be configured to determine the intrinsic parameters of the cameras acting as the user's two eyes. Intrinsic parameters describe the internal characteristics of a camera, including focal length, principal point, and lens distortion. They define how the camera projects three-dimensional points in the real world onto the two-dimensional image sensor. In some examples, the intrinsic parameters are calculated using a calibration process that involves capturing images of a calibration pattern (e.g., a chessboard), from various angles and positions. These images are then used to compute the camera matrix, which describes the internal geometry of the camera, including focal length, principal point, and lens distortion. Once calculated, the intrinsic parameters can be stored for use with the crosstalk calculations. As a technical effect, this permits the system to calculate crosstalk without issues associated with camera imperfections.

In some implementations, the determined crosstalk can correct or configure the display. For example, a system can update the optical elements, like lenticular lenses or parallax barriers, or can provide software compensation to limit the amount of crosstalk from the display. For example, suppose the device determines that a large amount of crosstalk is supplied from the upper left portion of the display to the user's left eye. In that case, a software configuration can be updated to adjust images or light intensity from that portion to limit the amount of crosstalk (i.e., limit the light from the display for the right eye to limit the crosstalk to the left eye). In some examples, the screen can be calibrated to change the light intensity associated with the right or left eye and the location on the display to limit the amount of crosstalk exhibited by the display. In some examples, the screen can also be calibrated based on the pose or position of the user relative to the display. This can correct crosstalk issues associated with limited poses of the user. Thus, while a first correction can be used for a first pose, a second correction can be used for a second pose.

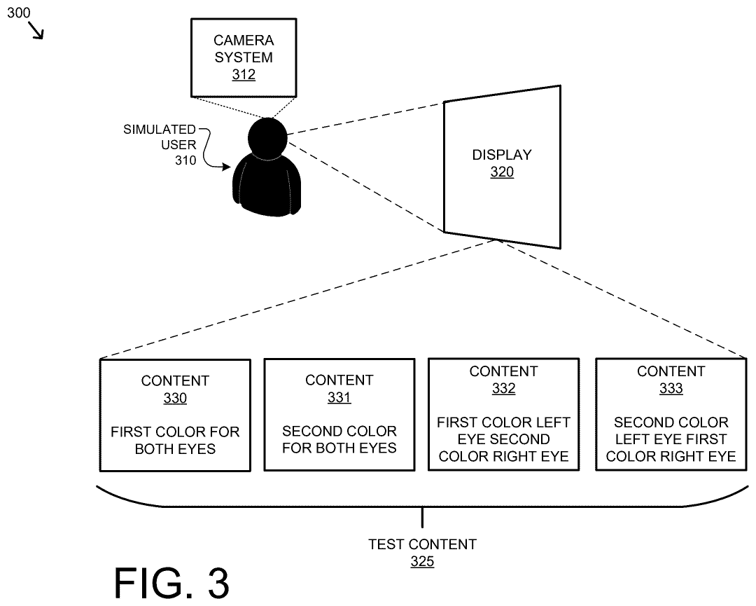

FIG. 3 illustrates an operational scenario 300 of capturing images to determine crosstalk associated with a display according to an implementation. Operational scenario 300 includes simulated user 310 with camera system 312, display 320, and test content 325 with content 330, 331, 332, and 333. Display 320 represents a 3D display, such as an autostereoscopic 3D display.

In operational scenario 300, simulated user 310 includes image capture system 312 capable of simulating a user viewing display 320. Image capture system 312 can be configured to act as the user's left and right eyes. In some examples, the image capture system 312 of the simulated user 310 can be mounted to a dummy or mannequin representing a user. In some implementations, the camera system 312 of the simulated user 310 is positioned at a pose relative to the display 320. In some examples, the camera system 312 associated with the simulated user 310 is used to identify a pose. A pose represents the position and orientation of the cameras (i.e., representing the user's eyes) in three-dimensional space. Once the pose is identified, image capture system 312 can capture test content 325 provided by display 320 to determine the crosstalk at the corresponding pose. In some examples, a pose for two cameras (i.e., capture system 312) representing a user's eyes can be determined using stereo calibration, which finds the relative position and orientation between the cameras by matching features in images captured at the same time. If the user's (or simulated user's) position is known in space, this information can be combined to get the pose of both eyes.

In the example of operational scenario 300, test content 325 can be configured to include content 330, 331, 332, and 333 provided by display 320. Content 330 provides a first color to both eyes, content 331 provides a second color to both eyes, content 332 provides the first color to the left eye and the second color to the right eye, and content 333 provides the second color to the left eye and the second color to the right eye. From the images, a test computing system, such as device 105 of FIG. 1, can determine the crosstalk from display 320 at the corresponding pose.

In some implementations, the crosstalk can be measured by measuring how much of an image is received by the unintended camera representing the user's eye. For example, the display can provide a first image for the camera representing a user's right eye, the first image including a first color (e.g., green). The display can further provide a second image for the camera representing the user's right eye, the second image including a second color (e.g., black). The device can determine the crosstalk to the right eye based on the amount of light (i.e., green) received by the camera representing the user's right eye. In some implementations, the ratio of light to intended light is calculated to show how much unwanted overlap occurs between the two views. This ratio can be determined as a percentage in some examples. In some examples, the measurement can be taken across the entire display 320. For example, the measurement can indicate the percentage of crosstalk associated with different subsets of the pixels of display 320. This can indicate that different portions of the display have different amounts of crosstalk, permitting a calibrator or engineer to identify the portions of the display with the worst crosstalk in some examples. The process can be repeated at different poses to identify characteristics associated with the different poses. The different poses can be used to identify crosstalk related to different user locations.

In some implementations, a system, such as device 105 of FIG. 1, can be configured to update display 320 based on the measured crosstalk. The system can update the optical elements, like lenticular lenses or parallax barriers, or can provide software compensation to limit the amount of crosstalk from the display. For example, if the device determines a large amount of crosstalk is provided from the upper left portion of the display to the user's left eye, a software configuration can be updated to adjust images or light intensity from that portion to limit the amount of crosstalk. In some examples, the screen can be calibrated to change the light intensity associated with the right or left eye and the location on the display to limit the amount of crosstalk exhibited by the display.

In some implementations, as part of the crosstalk determination, the steps of operational scenario 300 can be repeated at different locations. The various locations and measured crosstalk can be used to predict potential crosstalk at other (potentially) untested poses. For example, the device can measure crosstalk associated with the left eye channel and the right eye channel at different poses. The device can then predict the crosstalk associated with the display at different poses, orientations, or distances. In some examples, the device can predict the crosstalk for the right eye channel and the left eye channel for a particular pose or coordinate relative to the display. As a technical effect, rather than testing every pose, a subset of the poses can be used to predict the crosstalk at different viewing angles, assisting the developer in tuning the display.

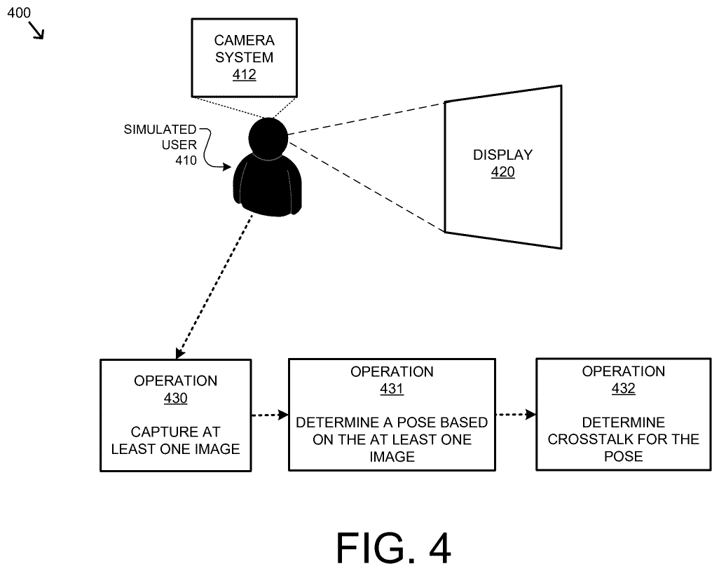

FIG. 4 illustrates an operational scenario 400 of determining a pose for a test camera system according to an implementation. Operational scenario 400 includes simulated user 410 with camera system 412, display 420, and operations 430, 431, and 432. A test computing system can implement operations 430, 431, and 432, such as test device 105 of FIG. 1 or computing system 700 of FIG. 7. Display 420 represents a 3D display, such as an autostereoscopic 3D display.

In operational scenario 400, display 420 displays a pattern captured by camera system 412. Camera system 412 can include cameras that represent the left eye and the right eye of simulated user 410. In some implementations, camera system 412 and simulated user 410 comprise a dummy or mannequin. In some examples, camera system 412 and simulated user 410 can be mounted to a robotic arm or other mechanism that positions camera system 412 like a viewing position of a user. Once in a position, display 420 can be configured to provide a test pattern to determine the extrinsic pose (e.g., location and orientation) of camera system 412 relative to display 420.

Camera system 412 captures, as part of operation 430, at least one image of display 420 with the test pattern. Operation 431 then determines at least one pose based on the at least one image captured by camera system 412 (i.e., the extrinsic pose). In some implementations, the system can determine the pose of camera system 412 relative to display 420 by using visual markers or features on the display surface. By capturing stereo images of the display and detecting known reference points, such as fiducial markers (e.g., ArUco markers) or screen content with predefined geometry, the device can determine the 3D positions relative to its own coordinate system. Once these 3D positions are established, camera system 412 can use an algorithm to compute the device's 6-DoF (degrees of freedom) pose (position and orientation) for display 420.

In some implementations, the pose determination can rely on the intrinsic characteristics of camera system 412. In some examples, the system can depend on intrinsic characteristics of the cameras, such as focal length, optical center, and lens distortion, because these parameters define how 3D points in the world are projected onto the 2D image planes of the cameras. Accurate pose estimation can depend on knowing these intrinsic values so that the system can correctly interpret the size, shape, and position of objects it sees. Without calibration, the depth from stereo vision and the angles used to calculate the device's position would be distorted or inaccurate, leading to errors in determining how the device is positioned relative to the display.

In some examples, the test computing system can determine the pose without fiducial markers. For example, the test computing system can use features on the display like corners, edges, and/or user/interface elements if it knows what the screen is supposed to look like. The test system can estimate the pose using geometry and depth cues by comparing images from both cameras and matching those features to a known screen layout.

After the pose of camera system 412 is determined relative to display 420, the test system can determine crosstalk for the determined pose as part of operation 432. In some implementations, camera system 412 can capture at least one image with the camera representing a user's right eye and at least one image with the camera representing the user's left eye. The system can determine the quantity of unwanted light received at each of the eyes. For example, display 420 can display a first color for the right eye and a second color for the left eye. The camera representing the right eye can capture an image and determine the quantity of unwanted light received that was intended for the left eye. In some implementations, this can be a ratio or a percentage. In some examples, the crosstalk can be determined across the display. For example, the crosstalk can include a first value in a first location and a second value in a second location. In some implementations, the crosstalk can be visually demonstrated across a display representation and can emphasize or promote portions of the display with crosstalk values that satisfy criteria. As a technical effect, a calibrator can identify portions with increased crosstalk. The identified portions can be used to update or modify the display configuration to improve the crosstalk results. In some examples, the system can execute a second determination to determine whether the modifications improved the crosstalk values.

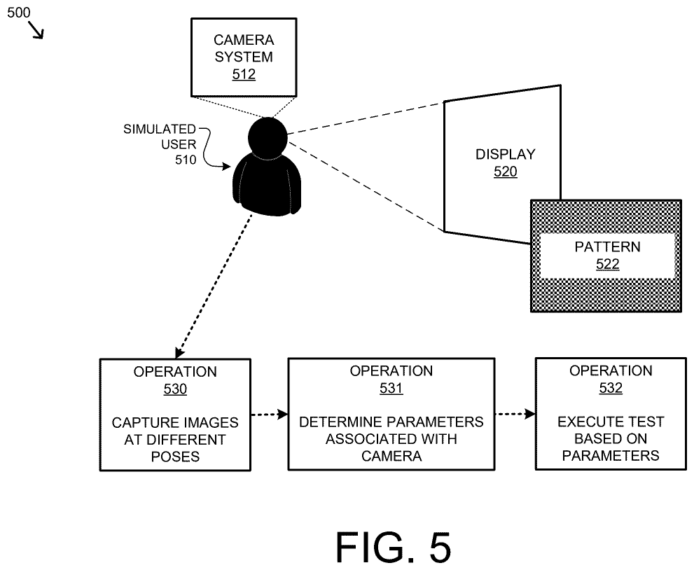

FIG. 5 illustrates an operational scenario 500 of determining extrinsic parameters associated with a test camera system according to an implementation. Operational scenario 500 includes simulated user 510 with camera system 512, display 520 with pattern 522, and operations 530, 531, and 532 that can be implemented by a test computing system, such as test device 105 of FIG. 1 or computing system 700 of FIG. 7. Display 520 represents a 3D display, such as an autostereoscopic 3D display.

In operational scenario 500, display 520 displays a pattern 522 that is captured by camera system 512. Camera system 512 can include cameras that represent the left eye and the right eye of simulated user 510. In some implementations, camera system 512 and simulated user 510 comprise a dummy or mannequin. In some examples, camera system 512 and simulated user 510 can be mounted to a robotic arm or other mechanism that positions camera system 512 various positions around display 520.

In some implementations, camera system 512 captures display 520 at different poses using operation 530. The test system further determines intrinsic parameters associated with the cameras of camera system 512 using operation 531. In some implementations, the test system can be configured to identify intrinsic parameters, such as focal length, distortion parameters, principal points, etc. To determine the intrinsic parameters, the device can execute a model that uses imaging information from the cameras to generate the parameters. In some implementations, the device can be configured to use a pattern, such as a ChArUco pattern, that is displayed and captured at different poses by the cameras. ChArUco calibration involves capturing multiple images of the ChArUco board from various angles and distances (i.e., poses) to detect the markers and chessboard corners. These detected points are then used to compute the camera's intrinsic parameters and distortion coefficients through a calibration algorithm. In some implementations, the device can be configured to use a model that processes the images to determine the required values. In some examples, the known 3D geometry of the pattern is compared to how it appears in the images to estimate the camera's internal characteristics, such as focal length, optical center, and lens distortion, that define how 3D points project onto the 2D image.

Once the intrinsic parameters are determined, the test system can be configured to execute a test based on the parameters. In some implementations, camera system 512 can be positioned at a first position (i.e., first pose) to receive one or more images associated with display 520. The test system can first capture an image of display 520 with a pattern 522 and determine a current pose for camera system 512 relative to display 520. Once the current pose is determined, the system can measure the crosstalk associated with the current pose of camera system 512. In some implementations, the intrinsic parameters are used to determine accurate image correction associated with the cameras, which can assist in isolating and measuring crosstalk. The intrinsic parameters can be used to provide undistorted and geometrically corrected images for crosstalk measurement.

In some implementations, once the intrinsic parameters are identified and the current pose is determined, the test system can capture images by the camera representing the right eye and the camera representing the left eye. In some implementations, the system can determine the crosstalk associated with a single eye (e.g., the right eye) at the current pose. In some implementations, the system can determine the crosstalk associated with both eyes. In some examples, the test system can capture, via camera system 512, one or more images of display 520 with a right eye camera and a left eye camera. The images can be used to determine the crosstalk or the quantity of unwanted light received by each camera. In some examples, the images can include a first image with a first color displayed for the left eye and a second color displayed for the right eye. In some examples, the images can include a second image with the second color displayed for the left eye and the first color displayed for the right eye. In some examples, the crosstalk can be measured across the display of 520 for both eyes, where different ratios of unwanted or crosstalk light can be determined for various portions of display 520. For example, for the camera representing a user's right eye, the test system can detect a first quantity of crosstalk in a first portion of display 520 and a second quantity of crosstalk in a second portion of display 520. Calculating crosstalk across the display can provide insight into configuration issues related to the display.

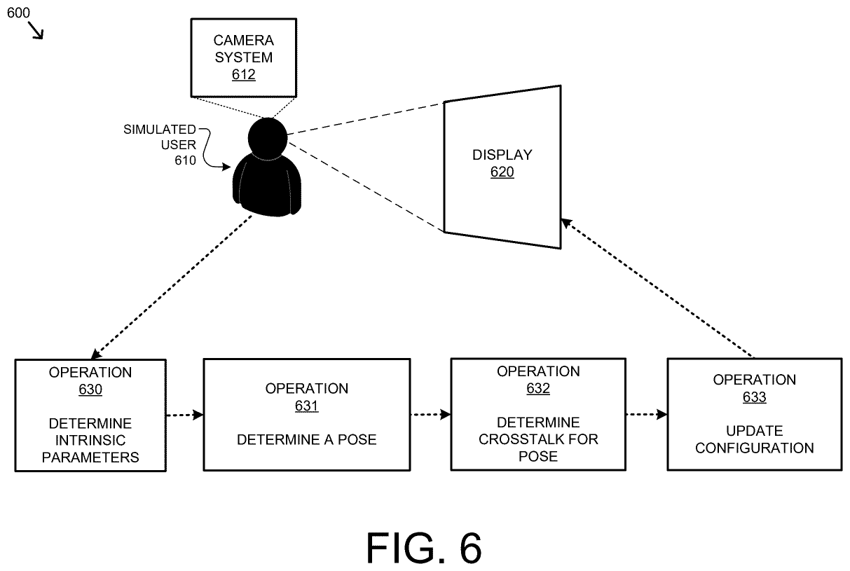

FIG. 6 illustrates an operational scenario 600 for changing a display configuration based on measured crosstalk according to an implementation. Operational scenario 600 includes simulated user 610 with camera system 612, display 620, and operations 630-633 that can be implemented by a test computing system, such as test device 105 of FIG. 1 or computing system 700 of FIG. 7.

In operational scenario 600, operation 630 is performed to identify intrinsic parameters associated with the cameras of camera system 612. Camera system 612 can include cameras that represent the left eye and the right eye of simulated user 610. The intrinsic parameters can include parameters like the focal length, optical center, and lens distortion associated with the camera. In some examples, the intrinsic parameters can be identified by using a pattern captured at various poses relative to display 620.

Operational scenario 600 further includes, after determining the intrinsic parameters, operation 631 in which a current pose is determined for camera system 612. In some implementations, camera system 612 of simulated user 610 is positioned at a first location to receive one or more images associated with display 620. In some examples, the pose can be determined using a ChArUco pattern (or another pattern) that is captured at the pose.

Operational scenario 600 further includes operation 632 that determines the crosstalk associated with the determined pose of camera system 612. In some implementations, camera system 612 can capture different types of images of display 620, where display 620 displays different content for the left eye and the right eye. The test system can determine the crosstalk or unwanted light received by each camera. For example, display 620 can display a first color for the right eye and a second color for the left eye. The test system can determine the amount of the second color received by the camera for the right eye and determine a crosstalk measurement for the right eye. In some implementations, the crosstalk measurement comprises a ratio or percentage. In some implementations, the crosstalk measurements can be determined for different portions of display 620. For example, a first portion of the display can include a first amount of crosstalk to the right eye of the user, while a second portion of the display can include a second amount of crosstalk to the right eye of the user.

Once the crosstalk measurement is determined, operation 633 updates the configuration of display 620 to mitigate or eliminate the crosstalk issues. In some implementations, the update can include adjusting one or more parameters associated with the lenses or projection device of display 620. For example, the angles of different lenses can be adjusted to direct light away from an eye of a user. Thus, if the camera associated with the right eye detected crosstalk that satisfies one or more criteria, display 620 can be updated to reduce or eliminate the crosstalk by adjusting parameters associated with lenses or projectors for the display.

FIG. 7 illustrates a computing system to determine crosstalk associated with a display according to an implementation. Computing system 700 is representative of any computing system or systems with which the various operational architectures, processes, scenarios, and sequences disclosed herein can be implemented to determine crosstalk associated with a display. Computing system 700 may represent a server, a laptop, a tablet, or another computing device. Computing system 700 can include multiple computing devices in some examples. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device. In some examples, communication interface 760 can communicate with a display to request content to be displayed on the display. For example, communication interface 760 can request that first content be displayed for a user's right eye and that second content be displayed for a user's left eye. In some examples, communication interface 760 can further communicate with one or more cameras that can capture the display (act as simulated user eyes).

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like. In some implementations, I/O device(s) 770 can include one or more cameras that act as a simulated user viewing a 3D display.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises crosstalk application 724. The operating software on storage system 745 may further include an operating system, utilities, drivers, network interfaces, applications, or some other type of software. When read and executed by processing system 750 the operating software on storage system 745 directs computing system 700 to operate as described in FIGS. 1-6.

In at least one implementation, crosstalk application 724 directs processing system 750 to to identify a first image and a second image of a display from a first camera and a second camera, where the first and second cameras are used to simulate a user viewing the display (i.e., 3D display). Crosstalk application 724 further directs processing system 750 to determine crosstalk for the display based on the first image and the second image. In some examples, crosstalk application 724 can direct processing system 750 to identify the crosstalk received by a camera representing an eye for a user using a set of images captured by the camera. The images can include different content, such as different colors, different colors or content for each eye, or some other content to capture and calculate unwanted light received at the cameras representing the user's eyes.

In some implementations, crosstalk application 724 directs processing system 750 to determine intrinsic parameters. The intrinsic parameters can include parameters like the focal length, optical center, and lens distortion associated with the camera or cameras. In some implementations, the intrinsic parameters can be used to correct for deformations or other issues associated with the lens of the cameras.

In some implementations, crosstalk application 724 directs processing system 750 to determine an extrinsic pose of the camera relative to the display. In some examples, the pose can be determined using a pattern provided on the display. Crosstalk application 724 can then direct processing system 750 to measure crosstalk for the display at the pose. In some implementations, the crosstalk is measured at a first camera representing a user's eye. In some implementations, crosstalk is measured by cameras that represent both eyes of the user. In some implementations, the crosstalk can be measured across the display, where different portions can include various amounts of crosstalk. In some implementations, the crosstalk can be measured at specific display portions (e.g., across sets of pixels). In some examples, the crosstalk for a first eye (e.g., left eye) can be calculated by the light intensity leaking from the second eye to the first eye divided by the combined light intensity of the light intended for the first eye and the light leaked from the second eye.

Below is example clauses associated with the present disclosure. The described clauses should not be considered exhaustive.
Clause 1. A method comprising: identifying a first image of a display from a first camera; identifying a second image of the display from a second camera; and determining a crosstalk for the display based on the first image and the second image.
Clause 2. The method of clause 1, wherein the first camera represents a first eye of a user, and wherein the first image captures the display providing first content for the first eye and second content for a second eye of the user.
Clause 3. The method of clause 2, wherein the first content comprises a first color and wherein the second content comprises a second color.
Clause 4. The method of clause 2, wherein the second camera represents the second eye of the user, and wherein the second image captures the display providing third content for the first eye and fourth content for the second eye of the user.
Clause 5. The method of clause 1, wherein the display comprises an autostereoscopic three-dimensional (3D) display.
Clause 6. The method of clause 1 further comprising: identifying one or more additional images of the display from the first camera; and identifying one or more additional images of the display from the second camera, wherein determining the crosstalk is further based on the one or more additional images of the display from the first camera and the one or more additional images of the display from the second camera.
Clause 7. The method of clause 1 further comprising: identifying a third image of the display from the first camera; identifying a fourth image of the display from the second camera; and determining a location of the first camera and the second camera based on the third image and the fourth image.
Clause 8. The method of clause 1, wherein the first image is captured at a first location and the second image is captured at a second location, and the method further comprising: identifying a third image of the display from the first camera, the third image captured at a third location; identifying a fourth image of the display from the second camera, the fourth image captured at a fourth location; and determining a second crosstalk for the display based on the third image and the fourth image.
Clause 9. A system comprising: at least one processor; a computer-readable storage medium operatively coupled to the at least one processor; and program instructions stored on the computer-readable storage medium that, when executed by the at least one processor, direct the system to perform a method, the method comprising: identifying a first image of a display from a first camera; identifying a second image of the display from a second camera; and determining a crosstalk for the display based on the first image and the second image.
Clause 10. The system of clause 9, wherein the first camera represents a first eye of a user, and wherein the first image captures the display providing first content for the first eye and second content for a second eye of the user.
Clause 11. The system of clause 10, wherein the first content comprises a first color and wherein the second content comprises a second color.
Clause 12. The system of clause 10, wherein the second camera represents the second eye of the user, and wherein the second image captures the display providing third content for the first eye and fourth content for the second eye of the user.
Clause 13. The system of clause 9, wherein the display comprises an autostereoscopic three-dimensional (3D) display.
Clause 14. The system of clause 9, wherein the method further comprises: identifying one or more additional images of the display from the first camera; and identifying one or more additional images of the display from the second camera, wherein determining the crosstalk is further based on the one or more additional images of the display from the first camera and the one or more additional images of the display from the second camera.
Clause 15. The system of clause 9, wherein the method further comprises: identifying a third image of the display from the first camera; identifying a fourth image of the display from the second camera; and determining a location of the first camera and the second camera based on the third image and the fourth image.
Clause 16. The system of clause 9, wherein the first image is captured at a first location and the second image is captured at a second location, and the method further comprising: identifying a third image of the display from the first camera, the third image captured at a third location; identifying a fourth image of the display from the second camera, the fourth image captured at a fourth location; and determining a second crosstalk for the display based on the third image and the fourth image.
Clause 17. The system of clause 9 further comprising the first camera and the second camera.
Clause 18. A method comprising: receiving a set of images from a camera, the set of images capturing an autostereoscopic display, and the camera representing an eye of a user; and determining a crosstalk for the autostereoscopic display based on the set of images.
Clause 19. The method of clause 18, wherein a first image in the set of images captures the autostereoscopic display displaying a first color for the eye of the user and a second color for a second eye of the user.
Clause 20. The method of clause 18 further comprising: receiving a second set of images from a second camera, the second set of images capturing the autostereoscopic display, and the second camera representing a second eye of the user.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
identifying a first image of a display from a first camera;
identifying a second image of the display from a second camera; and
determining a crosstalk for the display based on the first image and the second image.

2. The method of claim 1, wherein the first camera represents a first eye of a user, and wherein the first image captures the display providing first content for the first eye and second content for a second eye of the user.

3. The method of claim 2, wherein the first content comprises a first color and wherein the second content comprises a second color.

4. The method of claim 2, wherein the second camera represents the second eye of the user, and wherein the second image captures the display providing third content for the first eye and fourth content for the second eye of the user.

5. The method of claim 1, wherein the display comprises an autostereoscopic three-dimensional (3D) display.

6. The method of claim 1 further comprising:
identifying one or more additional images of the display from the first camera; and
identifying one or more additional images of the display from the second camera,
wherein determining the crosstalk is further based on the one or more additional images of the display from the first camera and the one or more additional images of the display from the second camera.

7. The method of claim 1 further comprising:
identifying a third image of the display from the first camera;
identifying a fourth image of the display from the second camera; and
determining a location of the first camera and the second camera based on the third image and the fourth image.

8. The method of claim 1, wherein the first image is captured at a first location and the second image is captured at a second location, and the method further comprising:
identifying a third image of the display from the first camera, the third image captured at a third location;
identifying a fourth image of the display from the second camera, the fourth image captured at a fourth location; and
determining a second crosstalk for the display based on the third image and the fourth image.

9. A system comprising:
at least one processor;
a computer-readable storage medium operatively coupled to the at least one processor; and
program instructions stored on the computer-readable storage medium that, when executed by the at least one processor, direct the system to perform a method, the method comprising:
identifying a first image of a display from a first camera;
identifying a second image of the display from a second camera; and
determining a crosstalk for the display based on the first image and the second image.

10. The system of claim 9, wherein the first camera represents a first eye of a user, and wherein the first image captures the display providing first content for the first eye and second content for a second eye of the user.

11. The system of claim 10, wherein the first content comprises a first color and wherein the second content comprises a second color.

12. The system of claim 10, wherein the second camera represents the second eye of the user, and wherein the second image captures the display providing third content for the first eye and fourth content for the second eye of the user.

13. The system of claim 9, wherein the display comprises an autostereoscopic three-dimensional (3D) display.

14. The system of claim 9, wherein the method further comprises:
identifying one or more additional images of the display from the first camera; and
identifying one or more additional images of the display from the second camera,
wherein determining the crosstalk is further based on the one or more additional images of the display from the first camera and the one or more additional images of the display from the second camera.

15. The system of claim 9, wherein the method further comprises:
identifying a third image of the display from the first camera;
identifying a fourth image of the display from the second camera; and
determining a location of the first camera and the second camera based on the third image and the fourth image.

16. The system of claim 9, wherein the first image is captured at a first location and the second image is captured at a second location, and the method further comprising:
identifying a third image of the display from the first camera, the third image captured at a third location;
identifying a fourth image of the display from the second camera, the fourth image captured at a fourth location; and
determining a second crosstalk for the display based on the third image and the fourth image.

17. The system of claim 9 further comprising the first camera and the second camera.

18. A method comprising:
receiving a set of images from a camera, the set of images capturing an autostereoscopic display, and the camera representing an eye of a user; and
determining a crosstalk for the autostereoscopic display based on the set of images.

19. The method of claim 18, wherein a first image in the set of images captures the autostereoscopic display displaying a first color for the eye of the user and a second color for a second eye of the user.

20. The method of claim 18 further comprising:
receiving a second set of images from a second camera, the second set of images capturing the autostereoscopic display, and the second camera representing a second eye of the user.
